(19) United States
(12) Patent Application Publication
(10) Pub. No.: US 2020/0242058 A1
(43) Pub. Date: Jul. 30, 2020

(54) INTERRUPT MANAGEMENT SYSTEM AND MANAGEMENT METHOD THEREOF

(71) Applicant: Faraday Technology Corp., Hsinchu City (TW)

(72) Inventors: Shih-Ching Lin, Hsinchu (TW); Chun-Yuan Lai, Hsinchu City (TW)

(73) Assignee: Faraday Technology Corp., Hsinchu City (TW)

(21) Appl. No.: 16/429,070

(22) Filed: Jun. 3, 2019

(30) Foreign Application Priority Data
Jan. 30, 2019 (CN) 201910092002.0

(51) Int. Cl. G06F 13/24; G06F 13/16

(52) U.S. Cl. CPC G06F 13/24; G06F 13/1668

(57) ABSTRACT

An interrupt management system and a management method thereof are provided. The interrupt management system includes a processor and an interrupt signal expanding controller. The processor receives a plurality of original interrupt signals. The interrupt signal expanding controller includes a decoder and an interrupt vector table. The decoder receives a plurality of expanding interrupt request signals, and decodes the expanding interrupt request signals to generate the original interrupt signals, where number of the expanding interrupt request signals is larger than number of the original interrupt signals. The interrupt vector table stores a plurality of interrupt vectors. The decoder reads one of the interrupt vectors to obtain an accessed interrupt vector according to the expanding interrupt request signals, and the interrupt signal expanding controller transmits the accessed interrupt vector to the processor.

### CROSS-REFERENCE TO RELATED APPLICATION

This application claims the priority benefit of China application serial no. 201910092002.0, filed on Jan. 30, 2019. The entirety of the above-mentioned patent application is hereby incorporated by reference herein and made a part of this specification.

### BACKGROUND

### Technical Field

The disclosure relates to an interrupt management system and management method thereof, and in particular to an expandable interrupt management system and management method thereof.

### Description of Related Art

In a known technology, a processor may read an interrupt vector table according to an interrupt signal and directly leads to an interrupt service routine. Many processors nowadays adopt vectored interrupts with high efficiency; however, some simplified or low power consuming processors only supports comparatively less interrupt numbers in order to save hardware resources, and therefore are likely to meet the dilemma of insufficient interrupt numbers; thus, the work efficiency of the processors is lowered down.

### SUMMARY

The disclosure provides an interrupt management system and management method thereof that may expand the provided interrupt vectors.

The interrupt management system of the disclosure includes a processor and an interrupt signal expanding controller. The processor receives a plurality of original interrupt signals. The interrupt signal expanding controller is coupled to the processor, and the interrupt signal expanding controller includes a first decoder and an interrupt vector table. The first decoder receives a plurality of expanding interrupt request signals, and decodes the interrupt request signals to generate original interrupt signals, wherein a number of the expanding interrupt request signals is larger than a number of the original interrupt signals. The interrupt vector table is coupled to the first decoder and stores a plurality of interrupt vectors, wherein the first decoder reads one of the interrupt vectors to generate an accessed interrupt vector according to the expanding interrupt request signals, and the interrupt signal expanding controller transmits the accessed interrupt vector to the processor.

The interrupt management method of the disclosure includes the following steps. An interrupt signal expanding controller is provided to receive a plurality of expanding interrupt request signals to decode the interrupt request signals to generate original interrupt signals, wherein a number of the expanding interrupt request signals is larger than a number of the original interrupt signals; the interrupt signal expanding controller is provided to read one of the interrupt vectors to generate an accessed interrupt vector according to the expanding interrupt request signals; and the interrupt signal expanding controller is provided to transmit the accessed interrupt vector to the processor.

Based on the above, the disclosure makes the comparatively more interrupt request signals correspond to the comparatively less original interrupt signals thorough the method of decoding through the interrupt signal expanding controller. Therefore, the number of the interrupt vector tables may be expanded to increase the work efficiency of the processor.

In order to make the features and advantages of the disclosure mentioned above more understandable, embodiments will be described in detail below with reference to the accompanying drawings.

### BRIEF DESCRIPTION OF THE DRAWINGS

FIG. 1 is a schematic view of a hardware structure of an interrupt management system according to an embodiment of the disclosure.

FIG. 2 is a schematic view of a hardware structure of the interrupt management system according to another embodiment of the disclosure.

FIG. 3 is a process chart of an interrupt management method according to an embodiment of the disclosure.

### DESCRIPTION OF THE EMBODIMENTS

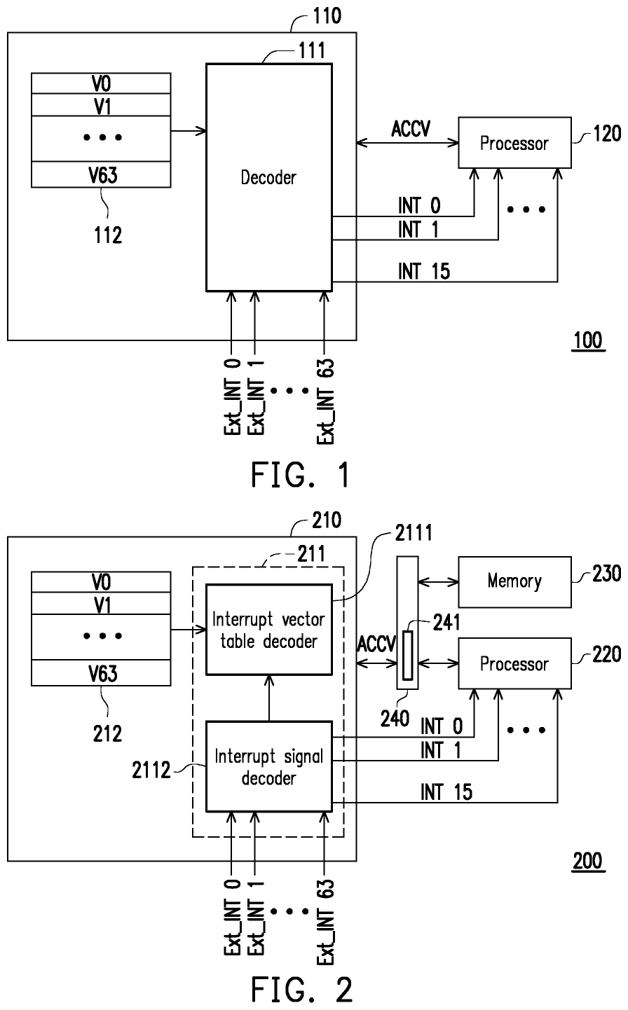

Please refer to FIG. 1. FIG. 1 is a schematic view of a hardware structure of an interrupt management system according to an embodiment of the disclosure. An interrupt management system 100 includes an interrupt signal expanding controller 110 and a processor 120. In the present embodiment, the processor 120 receives a plurality of original interrupt signals INT 0 to INT 15. The interrupt signal expanding controller 110 is coupled to the processor 120. The interrupt signal expanding controller 110 includes a decoder 111 and an interrupt vector table 112. The decoder 111 receives a plurality of expanding interrupt request signals EXT_INT 0 to EXT_INT 63, and decodes the received interrupt request signals EXT_INT 0 to EXT_INT 63 to generate the plurality of original interrupt signals INT 0 to INT 15, wherein a number of the expanding interrupt request signals EXT_INT 0 to EXT_INT 63 is more than a number of the plurality of original interrupt signals INT 0 to INT 15. In the present embodiment, the number of the expanding interrupt request signals EXT_INT 0 to EXT_INT 63 is, for example, 64, and the number of the original interrupt signals INT 0 to INT 15 is, for example, 16.

In other embodiments of the disclosure, the numbers of the expanding interrupt request signals and the original interrupt signals may be other numbers and is not limited hereto.

On another front, the decoder 111 decodes the received expanding interrupt request signals EXT_INT 0 to EXT_INT 63 to generate an access location information. The decoder 111 may read the interrupt vector table 112 through the access location information and obtain an accessed interrupt vector ACCV.

Please note that the interrupt vector table 112 stores a plurality of interrupt vectors V0 to V63, wherein the interrupt vectors V0 to V63 may respectively correspond to the expanding interrupt request signals EXT_INT 0 to EXT_INT 63. When one of the expanding interrupt request signals EXT_INT 0 to EXT_INT 63 is enabled (the expanding interrupt request signal EXT_INT 0 is taken as an example to be enabled), the decoder 111 may read one of the interrupt vectors V0 to V63 (the interrupt vector V0 for example) to obtain the accessed interrupt vector ACCV by decoding the expanding interrupt request signals EXT_INT 0 to EXT_INT 63 and through the generated access location information (corresponding to the interrupt vector V0).

The interrupt signal expanding controller 110 transmits the accessed interrupt vector ACCV to the processor 120, and the processor 120 may read the corresponding interrupt service routine according to the accessed interrupt vector ACCV and execute the interrupt service routine.

Please note that, in the present embodiment, the interrupt vector table 112 may be implemented by memory in any forms, and is not limited hereto.

In addition, the decoder 111 may perform the corresponding actions of the access location information and expanding interrupt request signals EXT_INT 0 to EXT_INT 63 through a method of disposing a conversion table. Specifically, taking the 64 expanding interrupt request signals EXT_INT 0 to EXT_INT 63 for example, the 64 access location information respectively corresponding to the expanding interrupt request signals EXT_INT 0 to EXT_INT 63 may be disposed in the decoder 111. When one of the expanding interrupt request signals EXT_INT 0 to EXT_INT 63 is enabled, the decoder 111 may find out the corresponding access location information according to the conversion table.

Regarding the corresponding aspect of the expanding interrupt request signals EXT_INT 0 to EXT_INT 63 and the original interrupt signals INT 0 to INT 15, the expanding interrupt request signals EXT_INT 0 to EXT_INT 63 may be divided into a plurality of groups according to the number of the original interrupt signals INT 0 to INT 15 in the decoder 111, and the plurality of groups therein respectively corresponds to the original interrupt signals INT 0 to INT 15. In the present embodiment, for example, the expanding interrupt request signals EXT_INT 0 to EXT_INT 63 may be averagely divided into 16 groups in order, wherein each group respectively corresponds to one of the original interrupt signals INT 0 to INT 15. For example, the group of the expanding interrupt request signals EXT_INT 0 to EXT_INT 3 corresponds to the original interrupt signal INT 0, the group of the expanding interrupt request signals EXT_INT 4 to EXT_INT 7 corresponds to the original interrupt signal INT 1, . . . , and the group of the expanding interrupt request signals EXT_INT 60 to EXT_INT 63 corresponds to the original interrupt signal INT 15. For example, when one of the expanding interrupt request signals EXT_INT 0 to EXT_INT 3 is enabled, the decoder 111 may enable the original interrupt signal EXT_INT 0 through the action of decoding.

The composition of the abovementioned groups and a corresponding relationship between the groups and the original interrupt signals INT 0 to INT 15 may be recorded in the lookup table, so that the decoder 111 may complete the action of decoding through the lookup table and quickly generate the original interrupt signals INT 0 to INT 15.

It is further worth mentioning that, the abovementioned conversion table and lookup table are designed to be adaptable to the method of dynamic adjustment; wherein the conversion table and the lookup table may be constructed through, for example, flash memory, and the content therein may be adjusted through programming.

The explanations mentioned above are only examples. In the embodiments of the disclosure, a quantity of the expanding interrupt request signals included by each group does not have to be the same, and the number of the expanding interrupt request signals included by each group does not have to be consecutive either. The designer may arrange the groups according to the timing of occurrence, probability and importance of each expanding interrupt request signals EXT_INT 0 to EXT_INT 63, which is not limited hereto.

Please refer to FIG. 2, FIG. 2 is a schematic view of a hardware structure of the interrupt management system according to another embodiment of the disclosure. The interrupt management system 200 includes an interrupt signal expanding controller 210, a processor 220, a memory 230 and a bus 240. The interrupt signal expanding controller 210 includes a decoder 211 and an interrupt vector table 212. The interrupt vector table 212 may be applied by memory in any form, and store a plurality of interrupt vectors V0 to V63. The decoder 211 includes an interrupt vector decoder 2111 and an interrupt signal decoder 2112. The interrupt signal decoder 2112 receives a plurality of expanding interrupt request signals EXT_INT 0 to EXT_INT 63 and decodes the expanding interrupt request signals EXT_INT 0 to EXT_INT 63 to generate the original interrupt signals INT 0 to INT 15.

On another front, the interrupt signal expanding controller 210 and the processor 220 in the embodiment of the disclosure are coupled to each other through the bus 240. In the present embodiment, a decoder 241 is disposed in the bus 240. In an aspect of action, when one of the original interrupt request signals INT 0 to INT 15 received by the processor 220 is enabled, the processor 220 may correspondingly transmit the interrupt service routine request to the bus 240; meanwhile, the decoder 241 may intercept the interrupt service routine request and decode the interrupt service routine request, and transmit the decoded interrupt service routine request to the interrupt signal expanding controller 210.

At the same time, the interrupt vector table decoder 211 of the interrupt signal expanding controller 210 receives the decoded interrupt service routine request, and generates an access location information according to the decoded interrupt service routine request, and reads the interrupt vector table 212 according to the access location information to obtain the accessed interrupt vector ACCV.

The interrupt signal expanding controller 210 transmits the accessed interrupt vector ACCV to the processor 220 through the bus 240. The processor 220 reads the memory 230 according to the accessed interrupt vector ACCV to read the corresponding interrupt service routine of the accessed interrupt vector ACCV to execute the interrupt service routine.

From the explanation mentioned above, it can be known that the interrupt service provided by the embodiments of the disclosure may expand from 16 original interrupt numbers to 64 expanding interrupt numbers through the disposal of the interrupt signal expanding controller 210 to effectively increase the work efficiency of the processor 220.

It is worth mentioning that, in the implementation of the disclosure, the processor 220 may be a processor chip or a processor circuit having computer capability in any forms. The memory 230 may be a memory in any forms, and the bus 240, which may also be in any forms, is a bus known by persons skilled in the art (such as AXI, AHB, Wishbone, or a bus in the form designed by other designers).

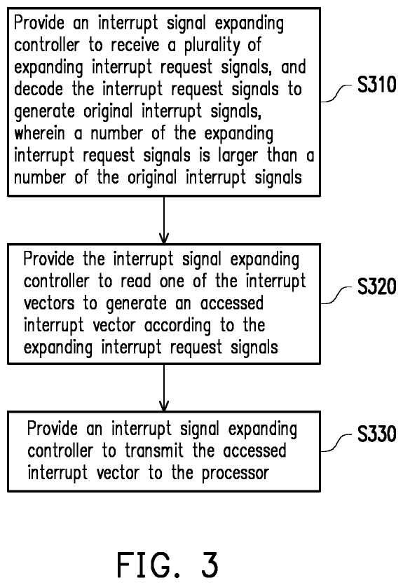

Please refer to FIG. 3. FIG. 3 is a process chart of an interrupt management method according to an embodiment of the disclosure. In FIG. 3. A step S310 provides an interrupt signal expanding controller to receive a plurality of expanding interrupt request signals to decode the plurality of expanding interrupt request signals to generate the plurality of original interrupt signals; and the number of the expanding interrupt request signals is larger than the number of the plurality of original interrupt signals. Further, in a step S320, the interrupt signal expanding controller is provided to read one of the plurality of interrupt vectors to generate an accessed interrupt vector according to the expanding interrupt request signals. Besides, in a step S330, an interrupt signal expanding controller is provided to transmit the accessed interrupt vector to the processor.

Regarding the method of implementation and details of the abovementioned steps, detailed explanations can be found in the aforementioned embodiments, and therefore would not be described again in the following content.

Based on the above, through disposing the interrupt signal expanding controller and disposing the expanded interrupt vector table in the interrupt signal expanding controller, the disclosure may effectively expand the interrupt signals by the method of coding. Thus, the number of interrupt signals may not be limited by the original frame, and may expand according to the requirements, so as to improve the work efficiency of the processor.

Although the disclosure has been disclosed in the above embodiments, the embodiments are not intended to limit the disclosure, and those skilled in the art may make some modifications and refinements without departing from the spirit and scope of the disclosure. Therefore, the scope of the disclosure is defined by the claims attached below.

What is claimed is:

1. An interrupt management system comprising:
a processor receiving a plurality of original interrupt signals; and
an interrupt signal expanding controller coupled to the processor, and the interrupt signal expanding controller comprises:
a first decoder receiving a plurality of expanding interrupt request signals to decode the plurality of expanding interrupt request signals to generate the plurality of original interrupt signals, wherein a number of the plurality of expanding interrupt request signals is larger than a number of the plurality of original interrupt signals; and
an interrupt vector table coupled to the first decoder, storing a plurality of interrupt vectors,
wherein the first decoder reads one of the plurality of interrupt vectors to generate an accessed interrupt vector according to the plurality of expanding interrupt request signals, and the interrupt signal expanding controller transmits the accessed interrupt vector to the processor.

2. The interrupt management system according to claim 1, further comprising:
a bus coupled between the processor and the interrupt signal expanding controller; and
a memory coupled to the bus.

3. The interrupt management system according to claim 2, further comprising:
a second decoder disposed in the bus, used to receive an interrupt service routine request transmitted by the processor to decode the interrupt service routine requirement and transmit the decoded interrupt service routine requirement to the interrupt signal expanding controller.

4. The interrupt management system according to claim 1, wherein the first decoder comprises:
an interrupt signal decoder receiving the plurality of expanding interrupt request signals to decode the plurality of expanding interrupt request signals to generate the plurality of original interrupt signals; and
an interrupt vector table decoder coupled to the interrupt signal decoder to generate an access location information according to the plurality of expanding interrupt request signals, and read one of the plurality of interrupt vectors in the interrupt vector table to generate the accessed interrupt vector according to the access location information.

5. The interrupt management system according to claim 4, wherein the interrupt signal decoder divides the plurality of expanding interrupt request signals into a plurality of groups, the plurality of groups respectively corresponds to the plurality of original interrupt signals, and the interrupt signal decoder enables each of the original interrupt signals according to a corresponding relationship between each of the group belonged by each of the enabled expanding interrupt request signals and each of the original interrupt signals.

6. An interrupt management method comprising:
providing an interrupt signal expanding controller to receive a plurality of expanding interrupt request signals to decode the plurality of expanding interrupt request signals to generate the plurality of original interrupt signals, wherein a number of the plurality of expanding interrupt request signals is larger than a number of the plurality of original interrupt signals;
providing the interrupt signal expanding controller to read one of the plurality of interrupt vectors to generate an accessed interrupt vector according to the plurality of expanding interrupt signals; and providing the interrupt signal expanding controller to transmit the accessed interrupt vector to the processor.

7. The interrupt management method according to claim 6 further comprising:
disposing a bus to couple between the processor and the interrupt signal expanding controller, wherein the bus is also coupled to the memory; and
when receiving an interrupt service routine request transmitted by the processor, the bus decodes the interrupt service routine request, and transmits the decoded interrupt service routine request to the interrupt signal expanding controller.

8. The interrupt management method according to claim 6, wherein the steps of decoding the plurality of interrupt request signals to generate the plurality of original interrupt signals comprise:
dividing the plurality of expanding interrupt request signals into a plurality of groups, and the plurality of groups respectively corresponds to the plurality of original interrupt signals; and
enabling each of the original interrupt signals according to a corresponding relationship between each of the group belonged by each of the enabled expanding interrupt request signals and each of the original interrupt signals.
